(19) United States
(12) Patent Application Publication
(10) Pub. No.: US 2005/0052130 A1
(43) Pub. Date: Mar. 10, 2005

(54) Light emitting device with optical enhancement structure

(75) Inventors: An-Chi Wei, Keelung City (TW); Heng-Long Yang, Taipei City (TW); Han-Ping Shieh, Hsinchu City (TW)

Correspondence Address: LIU & LIU, 811 WEST 7TH STREET, SUITE 1100, LOS ANGELES, CA, 90017, US

(73) Assignee: Toppoly Optoelectronics Corp.

(21) Appl. No.: 10/938,928

(22) Filed: Sep. 9, 2004

(30) Foreign Application Priority Data
Sep. 9, 2003 (TW) 92124844
Sep. 12, 2003 (TW) 92125333

(51) Int. Cl. H01J 1/62; H01J 63/04

(52) U.S. Cl. 313/506

(57) ABSTRACT

A light emitting device with optical enhancement structure. The light emitting device includes a light emitting element and an optical enhancement structure. Some of the light from the light emitting element is emitted in a diverging manner. The optical enhancement structure have an optical characteristic that directs diverging light from the light emitting element along a path within the optical enhancement structure in a direction towards a normal of the pixel. Light output efficiency is enhanced by means of the optical enhancement structure.

This invention relates to concurrently filed, copending patent application Ser. No. ______ (Attorney Docket No. 1176/211), which has been commonly assigned to the assignee of the present invention.

### BACKGROUND OF THE INVENTION

1. Field of the Invention

The present invention relates to light emitting devices, and more particularly to an organic light emitting device including an optical enhancement structure.

2. Description of the Related Art

Light output efficiency in conventional organic light emitting devices (OLED) and polymer light emitting devices (PLED) is insufficient due to total internal reflection (TIR) and the waveguide effect. Therefore, the actual light output efficiency is still very low although the internal quantum efficiency is near 100%.

FIG. 2 is a cross-section of a conventional organic light emitting device, only showing a pixel P₁ region for simplicity. The pixel P₁ includes a substrate 10, a reflective anode 20 formed on the substrate 10, an organic light emitting layer 22 formed on the reflective anode 20, a transparent cathode 24 formed on the organic light emitting layer 22, and a passivation layer 900 formed on the transparent cathode 24. As shown in FIG. 2, light beam L₁, emitted from the edge of the organic light emitting layer 22, reaches the boundary 901 of the pixel P₁ and cannot successfully emerge from the front of the device as useful light output.

FIG. 1 shows a cross-section of a prior art OLED structure, including a glass substrate 100, a transparent anode 200, an organic light emitting layer 220, an opaque cathode 240, and a hemispherical micro-lens array 300. The light output efficiency, however, is still not adequate with this more complex structure. Möller et al. (J. of Appl. Phys., Vol. 91, No. 5, pp. 3324-3327, 2002) discloses an example of a prior art structure that uses hemispherical micro-lens arrays to enhance light output efficiency of an OLED.

### SUMMARY OF THE INVENTION

The present invention solves the above-mentioned problems and provides a light emitting device with high light output efficiency. The present invention uses an optical enhancement structure that directs diverging light from the light emitting layer along a path within the optical enhancement structure towards closer to the normal to emerge more light from the pixel to improve light output efficiency. In one aspect of the invention, the optical enhancement structure bends diverging light from the light emitting layer along a path within the optical enhancement structure, towards the normal of the pixel. In one embodiment, this may be accomplished with an optical enhancement structure having a refractive index profile that bends the diverging light from the light emitting layer towards the normal of the pixel. In another embodiment, the optical enhancement structure is structured with gradually changing refractive indices along the light output pathway of the organic light emitting device. The refractive indices decrease through the optical enhancement structure, towards the direction in which light emerges. The optical enhancement structure may be a single monolithic layer having a refractive index gradient, or comprise several layers of materials having different refractive indices. The optical enhancement structure may also serve additional functions, such as passivation of underlying layers, in addition to enhancing the light output. In other words, the optical enhancement structure could be combined with other layers such as passivation layer, cathode layers, etc. Thus, by diffracting light towards the normal of the pixel, more of the diverging light from the light emitting layer is directed to emerge from the pixel, thus enhancing light output efficiency.

In a particular embodiment, the light emitting device includes a plurality of pixels, each pixel including a first electrode; an light emitting layer formed on the first electrode; and a second electrode formed on the organic light emitting layer. In one embodiment of the present invention, the light emitting device includes an optical enhancement structure formed on the second electrode, such that light emitted from the organic light emitting layer can pass through and emerge from the optical enhancement structure. In one embodiment of the present invention, the optical enhancement structure includes at least two optical enhancement layers consecutively disposed on the passivation layer and having different refractive indices than a refractive index of the passivation layer. In another embodiment, each consecutively disposed optical enhancement layer has a lower refractive index than the passivation layer and a preceding optical enhancement layer.

In another aspect of the present invention, the optical enhancement layer further includes a light emerging surface having features for minimizing total reflection of light. In one embodiment, the light emerging surface includes an arcuate profile, a faceted profile, or a beveled profile.

### BRIEF DESCRIPTION OF THE DRAWING

FIG. 1 is a cross-section of a conventional organic light emitting device with hemispherical micro-lens arrays.

FIG. 2 is a cross-section of a conventional organic light emitting device without an optical enhancement structure.

FIG. 3 is a cross-section of an organic light emitting device according to a first embodiment of the present invention.

FIG. 4 is a cross-section of an organic light emitting device according to a second embodiment of the present invention.

FIG. 5 is a cross-section of an organic light emitting device according to a third embodiment of the present invention.

FIG. 6 is a cross-section of an organic light emitting device according to a fourth embodiment of the present invention.

FIG. 7 is a cross-section of an organic light emitting device according to a fifth embodiment of the present invention.

FIG. 8 is a cross-section of an organic light emitting device according to a sixth embodiment of the present invention.

FIG. 9 is a cross-section of an organic light emitting device according to a seventh embodiment of the present invention.

FIG. 10 is a cross-section of conventional organic light emitting device with hemispherical micro-lens arrays.

FIG. 11 is a schematic diagram illustrating a light emitting display device of the present invention, incorporating a controller.

FIG. 12 is a schematic diagram illustrating an electronic device, incorporating the light emitting display device of the present invention.

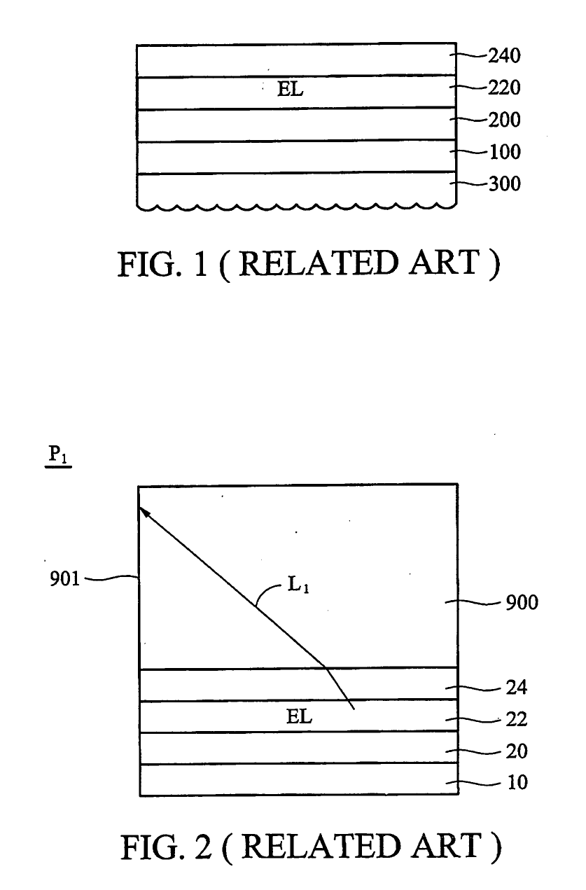

### DETAILED DESCRIPTION OF THE INVENTION

The present invention will be described below in connection with organic light emitting devices, to illustrate the general principle of the present invention. However, it is understood that the present invention is not limited to organic light emitting devices. Other types of light emitting devices can also take advantage of the present invention within the scope and spirit of the present invention.

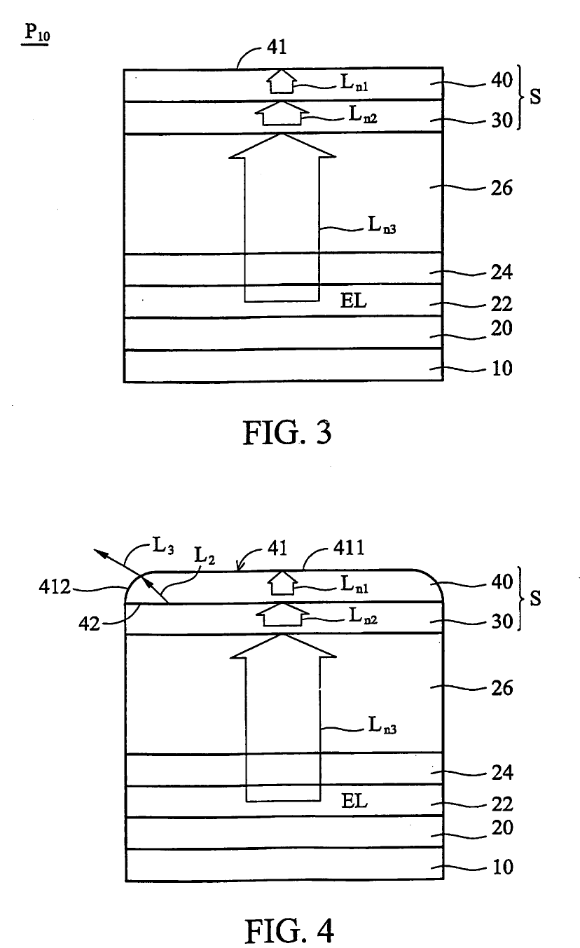

FIG. 3 is a cross-section view illustrating an organic light emitting device 1 according to a first embodiment of the present invention. For the sake of simplicity, FIG. 3 only shows a pixel region P₁₀ of the organic light emitting device. Further, there may be additional elements or components that are not shown in FIG. 3 but which may be present in the organic light emitting device.

Referring to FIG. 3, the pixel P₁₀ of the organic light emitting device includes a substrate 10, a reflective anode 20 formed on the substrate 10, an organic light emitting layer 22 formed on the reflective anode 20, a transparent cathode 24 formed on the organic light emitting layer 22, a passivation layer 26 formed on the transparent cathode 24, and an optical enhancement structure S formed on the passivation layer 26. The passivation layer 26 is optically coupled to the light emitting layer 22 and has a refractive index. The optical enhancement structure S includes a plurality of optical enhancement layers. For example, the optical enhancement structure S includes a first or inner optical enhancement layer 30 disposed on the passivation layer 26, and a second or outer optical enhancement layer 40 disposed on the first optical enhancement layer 30. The plurality of optical enhancement layers are optically coupled to the light emitting layer. The passivation layer and the plurality of optical enhancement layers are configured such that the refractive indices of these layers are in decreasing order from the passivation layer to the outer optical enhancement layer. In other words, the refractive index n2 of the first optical enhancement layer 30 is lower than the refractive index n3 of the passivation layer 26, while the refractive index n1 of the second optical enhancement layer 40 is lower than the refractive index n2 of the first optical enhancement layer 30.

The light emitting device of this embodiment of the present invention is configured such that the passivation layer 26 (FIG. 3) is thinner than the conventional passivation layer 900 (FIG. 2), and the total thickness of the passivation layer 26 and the optical enhancement structure S of the present invention can be kept approximately equal to or less than the thickness of the conventional passivation layer 900. Thus the present invention does not necessarily increase the thickness of the overall structure.

For example, the conventional passivation layer 900 is about 1000 μm thick, the passivation layer 26 of the present invention is about 700 μm thick, and the first and second optical enhancement layers 30 and 40 are about 150 μm each. Thus, light beam Lₙ₃ (as shown in FIG. 3), emitted from the organic light emitting layer 22, converges by the first and second optical enhancement layers 30 and 40 and successfully through the first and the second optical enhancement layers 30 and 40 as the light beam Lₙ₂ and Lₙ₁. That is, by passing through different media (i.e., layers 26, 30 and 40 with differing refractive indices n3, n2, and n1 to form a refractive index gradient in the optical enhancement structure S), light is converged and intensified, therefore, a portion of light that was originally blocked can emerge, thus enhancing light output efficiency.

As is illustrated by the foregoing embodiment, the present invention uses an optical enhancement structure that directs diverging light from the light emitting layer along a path within the optical enhancement structure towards closer to the normal to emerge more light from the pixel to improve light output efficiency. In one aspect of the invention, the optical enhancement structure bends diverging light from the light emitting layer along a path within the optical enhancement structure towards the normal of the pixel. In one embodiment, this may be accomplished with an optical enhancement structure having a refractive index profile that bends the diverging light from the light emitting layer towards the normal of the pixel. In another embodiment, the optical enhancement structure is structured with gradually changing refractive indices along the light output pathway of the organic light emitting device. The refractive indices decrease through the optical enhancement structure, towards the direction in which light emerges. The optical enhancement structure may be a single monolithic layer having a refractive index gradient, or as illustrated in the embodiment of FIG. 3, comprises several layers of materials having different refractive indices. The optical enhancement structure may also serve additional functions, such as passivation of underlying layers, in addition to enhancing the light output. In other words, the optical enhancement structure could be combined with other layers such as the passivation layer, cathode layers, or others.

As shown in FIG. 3, the light emerging surface 41 of the second optical enhancement layer 40 has a substantially flat or planar profile, but it is not limited to this. The light emerging surface 41 can also have a non-flat surface, such that the second optical enhancement layer 40 functions to reduce total reflection of light.

FIG. 4 is a cross-section of an organic light emitting device according to a second embodiment of the present invention, showing a non-flat light emerging surface. The pixel includes a substrate 10, a reflective anode 20, an organic light emitting layer 22, a transparent cathode 24, a passivation layer 26, and a first optical enhancement layer 30. Corresponding elements are the same as in FIG. 3 and detailed descriptions are thus omitted here. FIG. 4 differs from FIG. 3 in the second optical enhancement layer 40. In FIG. 4, the second optical enhancement layer 40 is a total reflection-reducing layer and includes a light emerging surface 41 and a bottom surface 42. The light emerging surface 41 includes first and second surfaces 411 and 412. The first surface 411 has a substantially flat profile, and the second surface 412 has an arcuate profile on each boundary of the first surface 411 to connect with the bottom surface 42. The arcuate profile of the second surface 412 can be smooth or be composed of a plurality of connecting faceted surfaces with gradually changed slopes.

As shown in FIG. 4, light beam Lₙ₃ is emitted from the organic light emitting layer 22 through the first and the second optical enhancement layers 30 and 40 as the light beam Lₙ₂ and Lₙ₁ and light beam L₂ reaches the second surface 412 of the second optical enhancement layer 40. Since the second surface 412 has an arcuate profile, the incident angle of the light bean L₂ is decreased to not exceed the critical angle. Thus, light beam L₂ will not be totally reflected but refract and emerge as the light beam L₃. That is to say, the light beam that is otherwise totally reflected can refract and emerge by means of the second surface 412 of the second optical enhancement layer 40 of the present invention, thus further increasing light output efficiency.

The configuration of the light emitting device shown in FIG. 4 facilitates light output efficiency. The passivation layer 26 is made thinner than the conventional passivation layer, and the refractive indices of the passivation layer and the two optical enhancement layers 30 and 40 are in gradual decreasing order. As a result, a light beam originally blocked by the boundary of the passivation layer can successfully emerge by the changed light pathway. Since the second surface 412 has an arcuate profile, light beam is no longer totally reflected and is able to emerge.

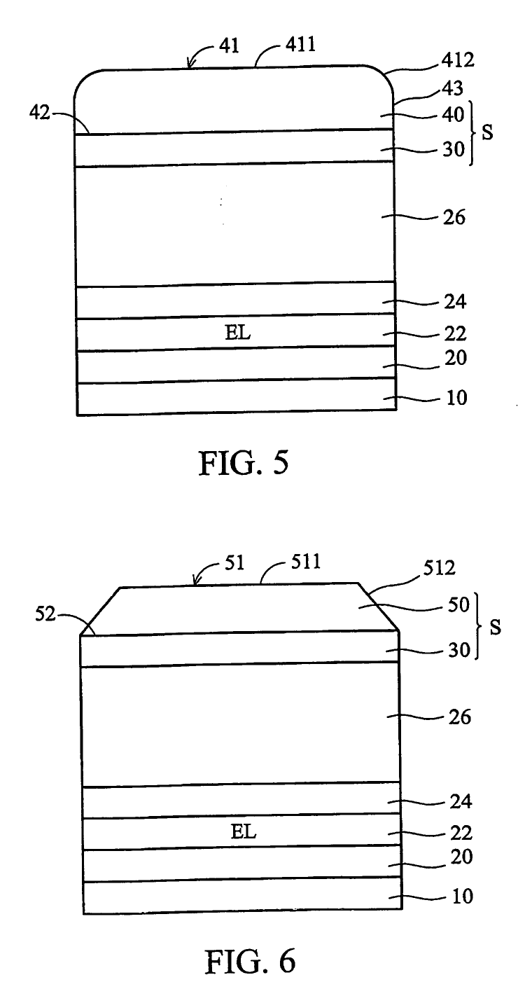

FIG. 5 is a cross-section of an organic light emitting device according to a third embodiment of the present invention. The pixel includes a substrate 10, a reflective anode 20, an organic light emitting layer 22, a transparent cathode 24, and a passivation layer 26. Corresponding elements are the same as in FIG. 3 and detailed descriptions are thus omitted here. FIG. 5 differs from FIG. 3 in the second optical enhancement layer 40. In FIG. 5, the second optical enhancement layer 40 is a total reflection-reducing layer and has a light emerging surface 41, a bottom surface 42, and a boundary 43. The light emerging surface 41 includes first and second surfaces 411 and 412. The first surface 411 has a substantially flat profile, and the second surface 412 has an arcuate profile on each side of the first surface 411. The second surface 412 connects the bottom surface 42 with the boundary 43.

Similar to FIG. 4, the passivation layer 26 is made thinner than the conventional passivation layer, and the refractive indices of the passivation layer and the two optical enhancement layers 30 and 40 are in gradual decreasing order. As a result, a light beam originally blocked by the boundary of the passivation layer can successfully emerge by the changed light pathway. Since the second surface 412 has an arcuate profile, light beam is no longer totally reflected and is able to emerge.

FIG. 6 is a cross-section of an organic light emitting device according to a fourth embodiment of the present invention. The pixel includes a substrate 10, a reflective anode 20, an organic light emitting layer 22, a transparent cathode 24, and a passivation layer 26. Corresponding elements are the same as in FIG. 3 and detailed descriptions are thus omitted here. FIG. 6 differs from FIG. 3 in the second optical enhancement layer. In FIG. 6, the optical enhancement structure S includes first and second optical enhancement layers 30 and 50. The second optical layer 50 is a total reflection-reducing layer and includes a light emerging surface 51 and a bottom surface 52. The light emerging surface 51 includes first and second surfaces 511 and 512. The first surface 511 has a substantially flat profile, and the second surface 512 has a slanted or faceted profile and is disposed on the sides of the first surface 511 to connect with the bottom surface 52.

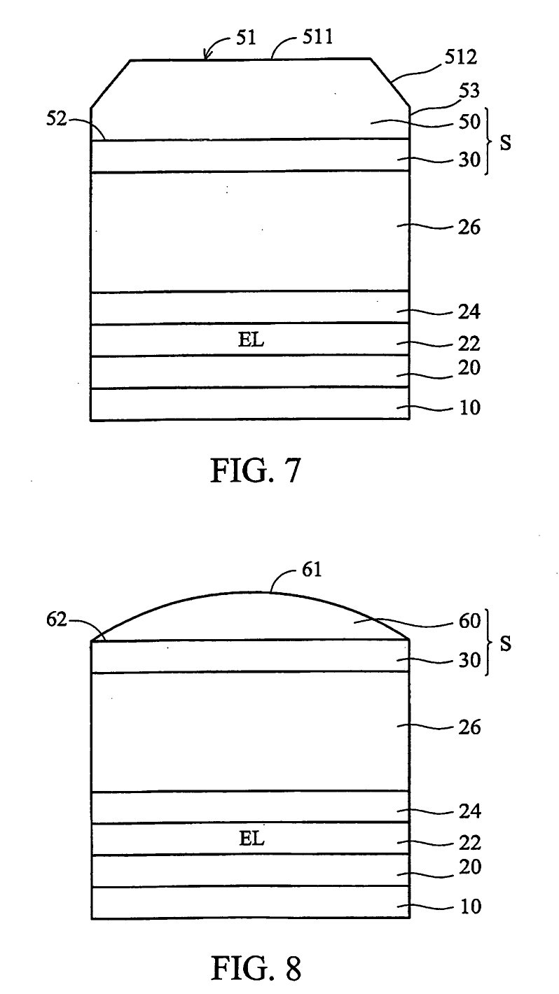

FIG. 7 is a cross-section of an organic light emitting device according to a fifth embodiment of the present invention. The pixel includes a substrate 10, a reflective anode 20, an organic light emitting layer 22, a transparent cathode 24, and a passivation layer 26. Corresponding elements are the same as in FIG. 3 and detailed descriptions are thus omitted here. FIG. 7 differs from FIG. 3 in the second optical enhancement layer. In FIG. 7, the optical enhancement structure S includes a first optical enhancement layer 30 and a second optical enhancement layer 50. The second optical enhancement layer 50 is a total reflection-reducing layer and includes a light emerging surface 51, a bottom surface 52, and a boundary 53. The light emerging surface 51 includes a first surface 511 and a second surface 512. The first surface 511 has a substantially flat profile, and the second surface 512 has a slanted or faceted profile and is on the sides of the first surface 511. The second surface 512 connects the bottom surface 52.

FIG. 8 is a cross-section of an organic light emitting device according to a sixth embodiment of the present invention. The pixel includes a substrate 10, a reflective anode 20, an organic light emitting layer 22, a transparent cathode 24, and a passivation layer 26. Corresponding elements are the same as in FIG. 3 and detailed descriptions are thus omitted here. FIG. 8 differs from FIG. 3 in the second optical enhancement layer. In FIG. 8, the optical enhancement structure S includes a first optical enhancement layer 30 and a second optical enhancement layer 60. The second optical enhancement layer 60 is a total reflection-reducing layer and has a light emerging surface 61 and a bottom surface 62. FIG. 8 shows that the light emerging surface 61 has an arcuate profile.

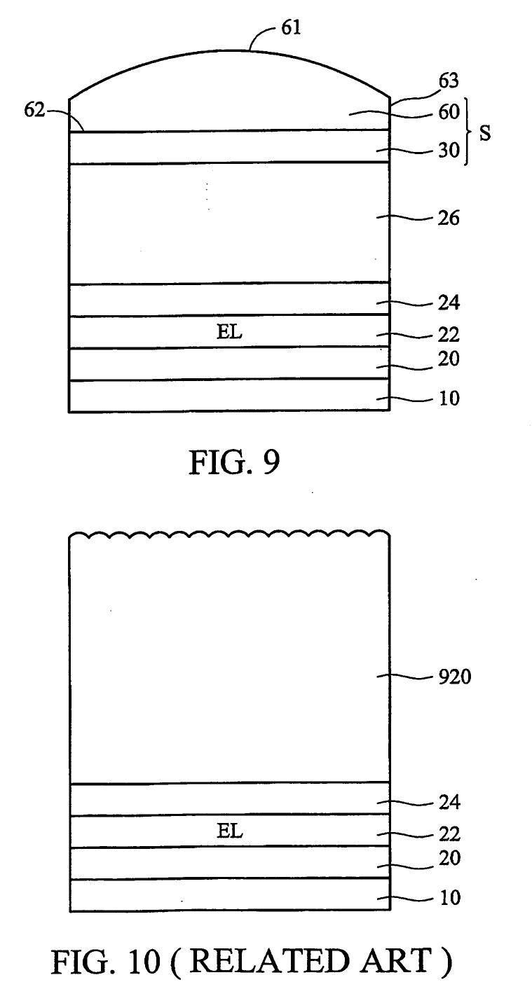

FIG. 9 is a cross-section of an organic light emitting device according to a seventh embodiment of the present invention. The pixel includes a substrate 10, a reflective anode 20, an organic light emitting layer 22, a transparent cathode 24, and a passivation layer 26. Corresponding elements are the same as in FIG. 3 and detailed descriptions are thus omitted here. FIG. 9 differs from FIG. 3 in the second optical enhancement layer. In FIG. 9, the optical enhancement structure S includes a first optical enhancement layer 30 and a second optical enhancement layer 60. The second optical enhancement layer 60 is a total reflection-reducing layer and has a light emerging surface 61, a bottom surface 62, and a boundary 63. The light emerging surface 61 connects the bottom surface 62 with the bounday 63. The light emerging surface 61 has an arcuate profile.

In all the above embodiments of the present invention, the optical enhancement structure includes two optical enhancement layers as an example, but it is not limited to this. The optical enhancement structure of the present invention can include multiple optical enhancement layers, and such as 2 to 10, preferably 2 to 5 optical enhancement layers. The optical enhancement structure of the present invention includes multiple optical enhancement layers consecutively disposed on the passivation layer, with the most inner enhancement layer having a refractive index lower than the refractive index of the passivation layer and each successively disposed enhancement layer having a lower refractive index than the refractive index of the preceding layer. That is, the optical enhancement layer closest to the passivation layer 26 has the largest refractive index, and that farthest from the passivation layer 26 has the smallest refractive index.

The reflective anode suitable for use in the present invention can be ITO (indium-tin-oxide) or IZO (indium-zinc-oxide) combined with a reflective film or a high work function metal film. The light emitting layer can be an organic light emitting layer that includes a hole transport layer (HTL), an emitting layer (EML) and an electron transport layer (ETL). The transparent cathode can be formed by coating a transparent metal film. The passivation layer can be a polymer.

Each optical enhancement layer can be a polymer and can be formed by coating, photolithography, and-etching applied in the semiconductor process; or can be a thermoplastic formed in a mold.

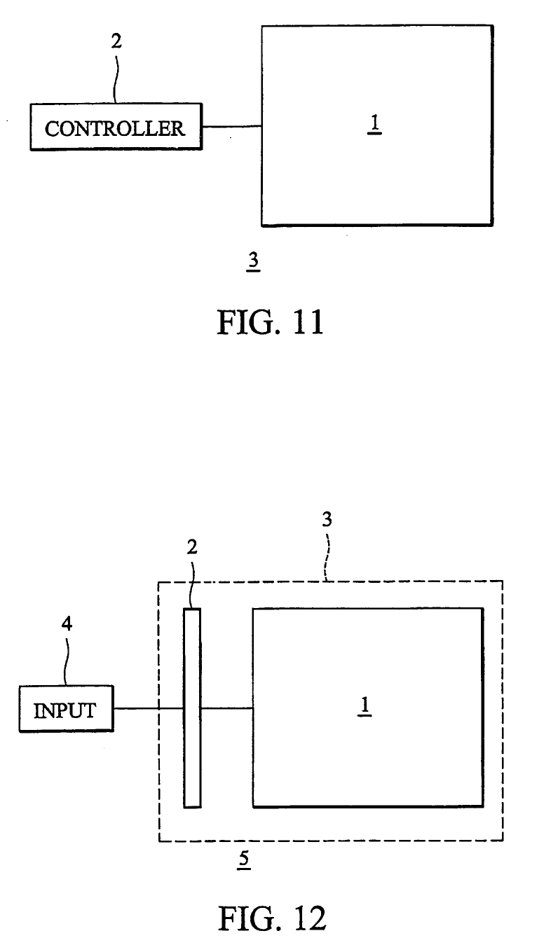

The light emitting device of the present can be coupled to a controller to form a light emitting display device. For example, the organic light emitting device 1 shown in FIG. 3 can be coupled to a controller 2, forming a light emitting display device 3 as shown in FIG. 11. The controller 2 can comprise a source and gate driving circuits (not shown) to control the light emitting device 1 to render image in accordance with an input. The light emitting display device 3 and associated controller 2 may be directed to an OLED type display device.

FIG. 12 is a schematic diagram illustrating an electronic device 5 incorporating the light emitting display device 3 shown in FIG. 11. An input device 4 is coupled to the controller 2 of the light emitting display device 3 shown in FIG. 11 to form an electronic device 5. The input device 4 can include a processor or the like to input data to the controller 2 to render an image. The electronic device 5 may be a portable device such as a PDA, notebook computer, tablet computer, cellular phone, or a display monitor device, or non-portable device such as a desktop computer.

Other types of light emitting devices may include PLED, plasma display, chemiluminescent display devices, backlit liquid crystal display devices, or the likes.

Computer Simulation

The models disclosed, of FIG. 2 (conventional), FIG. 3 (the present invention), and FIG. 10 (conventional) were created by computer simulation.

The following parameters were established: reflectivity of the reflective anode 20 at 100%, organic light emitting layer 22 with thickness of 0.15 μm and average refractive index of 1.75, transmittance of the transparent cathode 24 at 100%, and pixel width of 2000 μm.

Embodiment of FIG. 2 (conventional): the thickness of the passivation layer 900 is 1000 μm and n=1.4.

Embodiment of FIG. 3 (the present invention): the thickness of the passivation layer 26 is 700 μm and n=1.46. The thickness of the first optical enhancement layer 30 is 150 μm and n=1.4. The thickness of the second optical enhancement layer 40 is 150 μm and n=1.3.

Embodiment of FIG. 10 (conventional, micro-lens type): the thickness of the passivation layer 920 is 1000 μm and n=1.4. The micro-lens array has a curvature radius of 10 μm.

The computer simulation results are shown in Table 1. It can be seen that the OLED pixel structure of the present invention improves light output efficiency.

TABLE 1

| | Optical | Light |
|---|---|---|
| | enhancement | output |
| FIGURE | structure | efficiency |
| | None | 10% |
| (Conventional) | | |
| | Micro-lens | 13% |
| (Conventional) | type | |
| | Two optical | 14%-16% |
| (The present | enhancement | |
| invention) | layers | |

In conclusion, the light emitting device of the present invention has improved light output efficiency due to a thinner passivation layer and incorporation of at least two optical enhancement layers disposed on the passivation layer, with each successive layer from the passivation layer to the outer enhancement layer having a lower refractive index than the preceding layer. The pathway of the light beam is changed by the different media layers, allowing that light beam to emerge.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. For example, while the invention is illustrated by way of example of the optical enhancement layer being on side of the passivation layer away from the light emitting layer, the optical enhancement layer may be deployed above the light emitting layer, either below the passivation layer, or completely omitting the passivation layer. In other words, the optical enhancement layer may also function as a passivation layer. Also the optical enhancement layer may be a single layer of material having a refractive index gradient. All such modifications and variations are within the scope of the present invention as determined by the appended claims when interpreted in accordance with the breadth to which they are fairly, legally, and equitably entitled.

1. A light emitting device having a plurality of pixels, each pixel defined by a structure comprising:
a light emitting element, wherein some of the light from the light emitting element is emitted in a diverging manner; and
an optical enhancement structure, having an optical characteristic that directs diverging light from the light emitting element along a path within the optical enhancement structure in a direction towards a normal of the pixel.

2. The light emitting device as in claim 1, wherein the optical enhancement structure bends diverging light from the light emitting element to transmit along a path within the optical enhancement structure towards closer to the normal.

3. The light emitting device as in claim 2, wherein the optical characteristic of the optical enhancement structure comprises a refractive index profile that bends the diverging light from the light emitting element towards closer to the normal.

4. The light emitting device as in claim 3, wherein the refractive index profile comprises a gradient of refractive indices in the direction of the normal.

5. The light emitting device as in claim 4, wherein the refractive index profile comprises refractive indices that decrease in the normal direction.

6. The light emitting device as in claim 5, wherein the optical enhancement structure comprises at least two layers of materials having different refractive indices.

7. The light emitting device as in claim 6, wherein the optical enhancement structure comprises a light emerging surface that includes a central surface that is orthogonal to the normal and corner surfaces having profiles that are not orthogonal to the normal.

8. The light emitting device as in claim 7, wherein the corner surface profiles that comprise at least one of:
an arcuate profile,
a faceted profile, and
a beveled profile.

9. The light emitting device as in claim 7, wherein the optical enhancement structure comprises a convex light emerging surface.

10. The light emitting device as in claim 9, wherein the convex light emerging surface comprises an arcuate profile extending across the light emerging surface.

11. The light emitting device as in claim 1, wherein the light emitting element is one of OLED, PLED.

12. The light emitting device as in claim 1, further comprising a passivation layer disposed between the optical enhancement structure and the light emitting element, wherein the refractive index of the passivation layer is higher than the refractive index of the optical enhancement structure.

13. The light emitting device as claimed in claim 1, wherein the optical enhancement structure comprises at least two consecutive optical enhancement layers including inner and outer optical enhancement layers, wherein the refractive indices of the consecutive optical enhancement layers are in gradual decreasing order from the inner to the outer layer.

14. The light emitting device as claimed in claim 13, further comprising a passivation layer disposed between the optical enhancement structure and the light emitting element, wherein the refractive index of the passivation layer is higher than the refractive index of the optical enhancement structure.

15. The light emitting device as claimed in claim 13, wherein the outer enhancement layer has a light emerging surface with a substantially flat profile.

16. The light emitting device as claimed in claim 13, wherein the outer optical enhancement layer is a total reflection-reducing layer having a light emerging surface, such that a portion of light totally reflected originally can pass through and emerge from the light emerging surface.

17. The light emitting device as claimed in claim 16, wherein the total reflection-reducing layer further comprises a bottom surface and a boundary and the light emerging surface connects to the bottom surface by the boundary.

18. The light emitting device as claimed in claim 1, wherein the light emitting element comprises:
a first electrode;
an organic light emitting layer formed on the first electrode; and
a second electrode formed on the organic light emitting layer.

19. The light emitting device as claimed in claim 18, wherein the first electrode is a reflective anode, the second electrode is a transparent cathode, and the optical enhancement structure is formed on the transparent cathode.

20. The light emitting device as claimed in claim 19, further comprising a substrate with the reflective anode formed on the substrate.

21. A display device, comprising:
a light emitting device as in claim 1; and
a controller coupled to the light emitting device to control the light emitting device to render an image in accordance with an input.

22. An electronic device, comprising:
the display device as in claim 21; and
an input device coupled to the controller of the light emitting display device to control the light emitting display device to render an image.

23. A method of enhancing light output from a light emitting element of a pixel in a light emitting device, comprising the steps of:
providing an optical enhancement structure that has an optical characteristic that refracts incident light to transmit along a path within the optical enhancement structure towards a normal of the structure; and
optically coupling the optical enhancement structure to the light emitting element to direct diverging light from the light emitting element along a path within the optical enhancement structure towards a normal of the pixel.
